(19) United States
(12) Patent Application Publication
(10) Pub. No.: US 2016/0012007 A1
(43) Pub. Date: Jan. 14, 2016

(54) Digital Microphone Interface

(71) Applicant: Knowles Electronics, LLC, Itasca, IL (US)

(72) Inventors: Robert A. Popper, Lemont, IL (US); Wei-Wen Dai, Elgin, IL (US)

(21) Appl. No.: 14/635,441

(22) Filed: Mar. 2, 2015

Related U.S. Application Data
(60) Provisional application No. 61/948,866, filed on Mar. 6, 2014.

(51) Int. Cl. G06F 13/42; H04R 19/04; G06F 13/40

(52) U.S. Cl. CPC G06F 13/4273; G06F 13/4027; H04R 19/04

(57) ABSTRACT

A plurality of sensors are coupled to a data transmission bus and a command line. A marker is transmitted across the command transmission line. The marker is sensed at each of the plurality of the sensors. At each of the plurality of sensors, data is transmitted over the data bus at a predetermined time from the marker. Each predetermined time for each of the plurality of sensors is different from the predetermined time at the other sensors. Data transmitted from each of the plurality of sensors does not interfere with data transmitted from others of the plurality of sensors.

### CROSS REFERENCE TO RELATED APPLICATION

This patent claims benefit under 35 U.S.C. § 119 (e) to United States Provisional Application No. 61948866 entitled “Digital Microphone Interface” filed Mar. 6, 2014, the content of which is incorporated herein by reference in its entirety.

### TECHNICAL FIELD

This application relates to acoustic devices and, more specifically, to interfacing with these devices.

### BACKGROUND OF THE INVENTION

Various types of microphones and receivers have been used through the years. In these devices, different electrical components are housed together within a housing or assembly. For example, a microphone typically includes an acoustic sensing element consisting of an electret or a micro-electromechanical system (MEMS) device and a diaphragm, integrated circuits, among other components and these components are housed within the housing. Other types of acoustic devices may include other types of components. These devices may be used in hearing instruments such as hearing aids or in other electronic devices such as cellular phones and computers.

A digital interface can be used to receive data from or send data to the microphone. However, previous digital microphone interfaces lacked the capability required for the features utilized by digital microphones.

Additionally, factory calibration of the microphone has become important for manufacturing. Previous digital microphone interfaces only allowed for two microphones connected to a single clock and data bus. The previous buses also only transmits pulse density modulation (PDM) data and requires connecting to devices that contain decimation filters to convert that data to a pulse code modulation (PCM) form. All these problems have resulted in some user dissatisfaction with previous approaches.

### BRIEF DESCRIPTION OF THE DRAWINGS

For a more complete understanding of the disclosure, reference should be made to the following detailed description and accompanying drawings wherein:

FIG. 1 is a block diagram of a system including a digital microphone interface according to various embodiments of the present invention;

FIG. 2 is a block diagram of a command structure according to various embodiments of the present invention;

FIG. 3 is a state transition diagram showing microphone operation according to various embodiments of the present invention;

FIGS. 4A and 4B provide partial views intended to form one complete view of a block diagram of a timing diagram of system operation for an eight microphone system according to various embodiments of the present invention;

FIG. 5 is a block diagram of a timing diagram for system operation for a four microphone system according to various embodiments of the present invention.

Skilled artisans will appreciate that elements in the figures are illustrated for simplicity and clarity. It will further be appreciated that certain actions and/or steps may be described or depicted in a particular order of occurrence while those skilled in the art will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION

In the approaches described herein, a digital interface with a microphone is provided. A large number of devices can be connected to a data bus, and information can be exchanged with the microphones connected to the bus. Each of the microphones synchronizes data transmissions to a received marker signal such as a word strobe (WS) signal that is received over a transmission line. Data may be transmitted or received over the WS line. In so doing, the operation of the various microphones is synchronized so that each of the microphones transmits information at a predetermined time that does not interfere with the operation or transmissions of the other microphones. By sensing the marker, each microphone will understand and be configured to transmit a certain time length from the marker. Once the marker is no longer needed, the data transmission line used by the marker can be utilized for other purposes (e.g., transmissions of commands to the microphone). The present approaches also are used with and compatible with existing standards such as the I2S standard.

In many of these embodiments, a plurality of sensors are coupled to a data transmission bus and a command line. A marker is transmitted across the command transmission line. The marker is sensed at each of the plurality of the sensors. At each of the plurality of sensors, data is transmitted over the data bus at a predetermined time from the marker. Each predetermined time for each of the plurality of sensors is different from the predetermined time at the other sensors. Data transmitted from each of the plurality of sensors does not interfere with data transmitted from others of the plurality of sensors.

In some aspects, the plurality of sensors comprise a plurality of proximity sensors, a plurality of ambient light sensors, or a plurality of micro electro mechanical system (MEMS) microphones. Other examples are possible. In other aspects, the marker comprises a word strobe (WS) signal.

In other examples, a clock signal is transmitted to each of the plurality of sensors. In some examples, the frequency of the clock signal is at least partially effective to configure each of the plurality of sensors. In other examples, the frequency of the clock signal relates to a number of the sensors that are coupled to the data bus.

In some aspects, the marker comprises a word strobe (WS), and the word strobe is removed and replaced by command and control signals. In some examples, the data is audio data. In some aspects, the audio data is in a pulse code modulation (PCM) format.

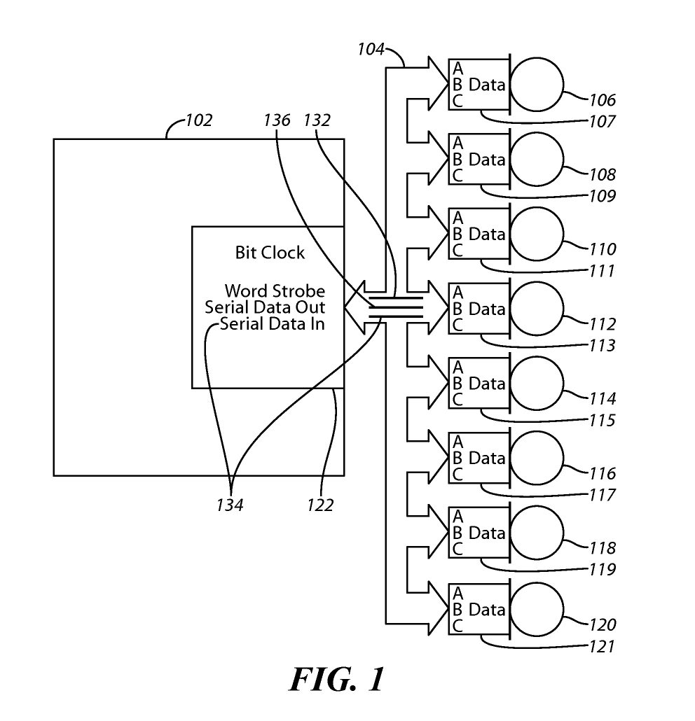

Referring now to FIG. 1, one example of a system of microphones that uses a digital interface is described. A processor 102 couples to a data bus 104. Microphones 106, 108, 110, 112, 114, 116, 118, and 120 are coupled to the data bus 104.

The processor 102 includes a hardware block 122 and may be either a codec or an applications processor. The hardware block 122 is configured to transmit a word strobe (WS) signal, transmit a clock signal, transmit serial data out, and receive serial data input from the bus 104. In the present approaches, the processor 102 may be a codec or application processor. The processor 102 may issue commands to specific microphones connected to the bus 104. In one aspect and when only two microphones are used, the processor 102 may be coupled to the microphones in an I2S format mode.

The bus 104 bus may be compliant with the I2S interface standard. In one aspect, the bus 104 utilizes a Clock (CLK) line 132 and a Data Input (DIN, data output from the microphone) line 134. A Data output (DOUT) line 136 of the bus 104 will emulate the Word Strobe (WS) line and allow for command and control of the microphones 106, 108, 110, 112, 114, 116, 118, and 120 (or other devices) connected to the bus 104. The DOUT line is flexible in usage since it is software-controlled by the host processor 102.

In one example, the bus 104 has modes for configuring 1, 2, 4 or 8 microphones based on the frequency of the CLK line. Each frequency will currently allow for 24 bit, 48 KHz audio from each of the microphones 106, 108, 110, 112, 114, 116, 118, and 120. Any number of microphones (e.g., 8), could be connected to the bus 104, but the frequency required will need to be at least the next highest multiple of 2. For example, if only 3 microphones are required, the bus will be run at the 4 microphone speed.

In one example and for the microphones 106, 108, 110, 112, 114, 116, 118, and 120, the CLK line operates at approximately 12.288 MHz and allows each microphone 106, 108, 110, 112, 114, 116, 118, and 120 to have 31 bits of data output. The output of each microphone 106, 108, 110, 112, 114, 116, 118, and 120 will be 24 bit PCM followed by 7 bits of data. In one aspect, one bit is reserved to allow each of the microphones to switch control of the DIN line. During this bit, the controlling microphone will release the DIN line, switch to high impedance, and the next controlling microphone will attach, or drive the line. In one example and for 4 microphones, the CLK line is driven at approximately 6.144 MHz. In another example and for 2 microphones, the CLK line is driven at approximately 3.072 MHz.

In the case of a single microphone attached to the bus 104, a low power mode may be used. More specifically, the microphone can be driven at approximately 512 kHz and the word strobe frequency will drop to 16 kHz. This will allow 16 bits of audio to be transmitted with 16 bits of additional data. If the microphone is in PDM mode, all 32 bits will be used by the microphone for PDM data.

It will be appreciated that the clock signal (and its selected rate) is used for multiple purposes. The microphones 106, 108, 110, 112, 114, 116, 118, and 120 monitor the clock line to determine the microphones address on the bus 104. The microphone will then transfer data only during the timeslot allotted for the address assigned.

The speed of the clock will also change based on the number of microphones currently on the bus. For an 8 microphone bus and in one example, the clock rate can be approximately 12.228 MHz; 4 microphones can be clocked at approximately 6.144 MHz. For a 2 microphone configuration, the clock rate can be set to approximately 3.072 MHz. For a single microphone in low power mode, the clock may be dropped to approximately 784 KHz. Other examples of frequencies are possible.

In other aspects, the clock, along with the word strobe, will be used to synchronize both the sigma delta and the decimation filter, in each of the microphones 106, 108, 110, 112, 114, 116, 118, and 120 on the bus 104. The microphones 106, 108, 110, 112, 114, 116, 118, and 120 will synchronize such that all the microphones on the bus will transmit the sample taken at the falling edge of word strobe. This synchronization is maintained by the microphone 106, 108, 110, 112, 114, 116, 118, and 120 such that after a synchronization cycle, the word strobe may be removed and replaced by command and control signals sent by the processor 102.

The bus 104 is a time division multiplexed type data bus. In one example, each microphone 106, 108, 110, 112, 114, 116, 118, and 120 on the bus 104 has a specific 31 clock, timeslot on the word strobe cycle. Microphones or other devices connected to the bus may be capable of using two or more of the timeslots in order to transmit the data necessary. However, two microphones are not be assigned the same timeslot.

The present approaches allow the microphones 106, 108, 110, 112, 114, 116, 118, and 120 to deliver 31 bits of data from each microphone 106, 108, 110, 112, 114, 116, 118, and 120 during each word strobe cycle. The microphones 106, 108, 110, 112, 114, 116, 118, and 120 will break the data up into 24 bits of audio data and 7 bits of microphone response data. Data on the DIN signal is valid on the rising edge of the clock signal.

In some aspects, the 24 bits of audio data is PCM formatted. The data is left justified with the most significant bit occupying the first data clock. The next 7 bits will be used for command response data. The response data may take on any number of formats.

The final bit of the sequence is required to release the bus. The microphone 106, 108, 110, 112, 114, 116, 118, and 120 will transition the state of the DIN line to a high impedance state such that another microphone can take control of the bus 104.

The present approaches allow commands to be sent to the microphones 106, 108, 110, 112, 114, 116, 118, and 120 using the word strobe line. When power is applied to the microphones 106, 108, 110, 112, 114, 116, 118, and 120, the microphone enter as pass through a synchronization cycle where the word strobe will operate at 48 KHz for at least 8 cycles. In one aspect, only after synchronization is complete can the word strobe line be used for command and control signals (commands) to be sent from the processor 102 to the microphones.

For simplicity on the host processor 102, the word strobe line can be connected to the I2S Data out line and controlled with software. At initialization, the processor 102 may output the standard 48 kHz word strobe for eight cycles.

As mentioned and after the synchronization cycle is complete, commands may be sent to the microphones 106, 108, 110, 112, 114, 116, 118, and 120. A command may start 10 clock cycles after the falling edge of word strobe. In one example, there are 10 consecutive zeros prior to the start of any command. The command will start by sending a 6 bit start sequence. The start sequence for the command will dictate the revision of the protocol used by the device. In one example, the start byte will be an alternating 1-0 sequence or the equivalent of hexadecimal Ox2A (42 decimal).

When the bus 104 or an individual microphone 106, 108, 110, 112, 114, 116, 118, or 120 is enabled, the bus 104 passes through a synchronization cycle. This synchronization cycle includes eight non-command word strobe cycles. During this time, the microphones 106, 108, 110, 112, 114, 116, 118, and 120 on the bus 104 will not receive commands. This will allow the current microphone to calculate the timing and the microphone's individual address.

If, at any time a microphone 106, 108, 110, 112, 114, 116, 118, and 120 is not receiving a command, the bus asserts word strobe at the normal cycle. In one example, this is a 48 KHz word strobe.

In other aspects, each microphone 106, 108, 110, 112, 114, 116, 118, and 120 has a decoder block 107, 109, 111, 113, 115, 117, 119, and 121 that calculates the address of the microphone based on the connection to each of three pins. The decoder block also calculates the frequency of the bus 104 and does not allow the microphone to transmit data on a time slot that is undefined for the bus configuration. For example, if the clock on the bus 104 is driven at 6.144 MHz, and a microphone decodes its address as microphone number 8, this microphone must not transmit data.

It will be appreciated that the bus 104 could be expanded to couple to other output devices or sensors (i.e. other than microphones).

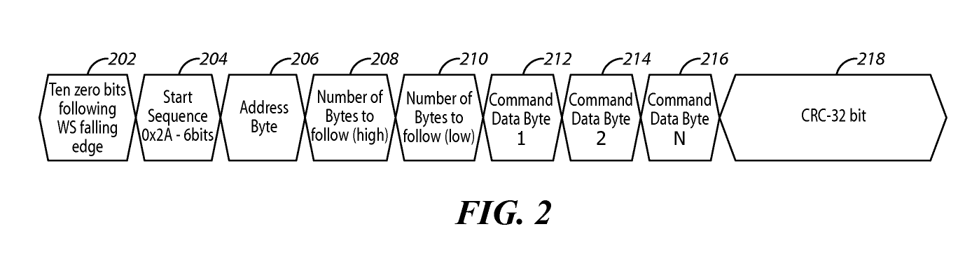

Referring now to FIG. 2, one example of a command 200 that is sent to the microphone over the WS line is described. A command may start 10 clock cycles after the falling edge of word strobe. A field 202 includes 10 consecutive zeros prior to the start of any command. The command will start by sending a 6 bit start sequence 204. The start sequence for the command will dictate the revision of the protocol used by the device. In one example, the start byte will be an alternating 1-0 sequence or the equivalent of hexadecimal Ox2A (42 decimal).

A byte 206 includes the address of the microphone being commanded on the bus. For example, to send a command to microphone number 5, the second byte can be a 0x05 (5 decimal). If a command is to be sent to all devices on the bus, this byte can be 0xff (255 decimal).

A byte 208 includes the length of the message in bytes (high) and a byte 210 includes the length of the message in bytes (low).

Following the bytes 208 and 210 are command bytes 212, 214, and 216 followed by a checksum byte 218 used for error detection/correction. The specific protocol for the device will depend on the actual device itself. This protocol may differ from device to device so the command structure will be dependent on the specific microphone type and configuration that is used.

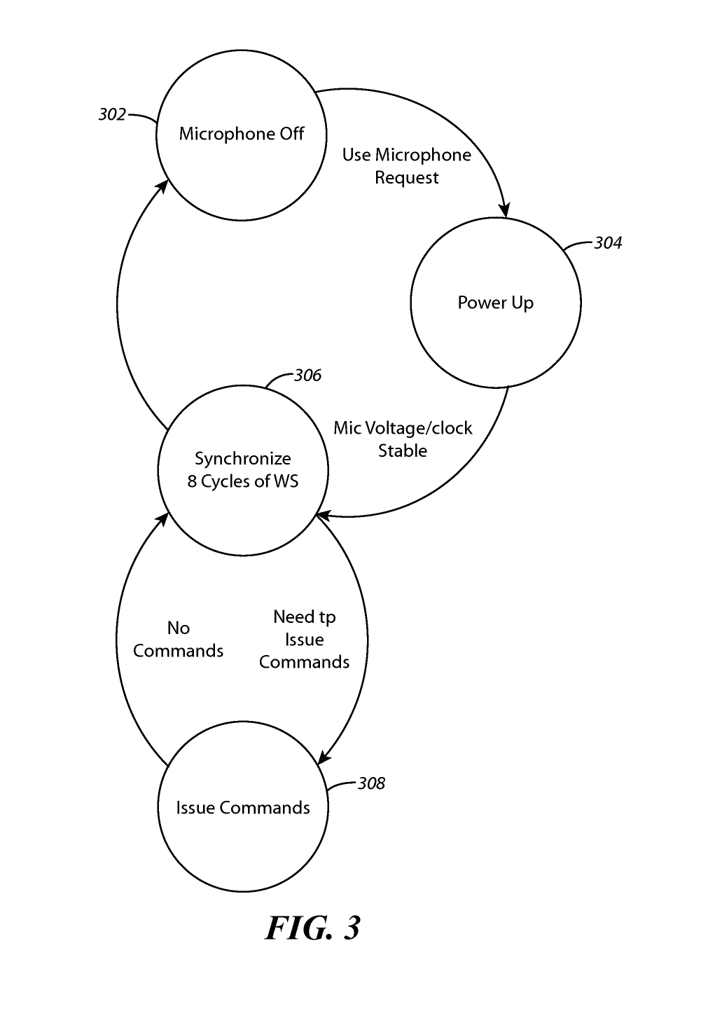

Referring now to FIG. 3, a state diagram that shows the flow of issuing commands is described. At state 302, the microphone begins in the powered down state and transitions to the power state 304 when power is applied.

When the clocks are stable, the microphone transitions to state 306 and the word strobe signal is clocked 8 times. At this point synchronization is achieved, and the microphones can place data to the bus and the word strobe may be removed (i.e., WS is no longer transmitted from the controller). At state 308, commands may now be issued to the microphones on the bus. When there is no need to issue commands, control returns to state 306.

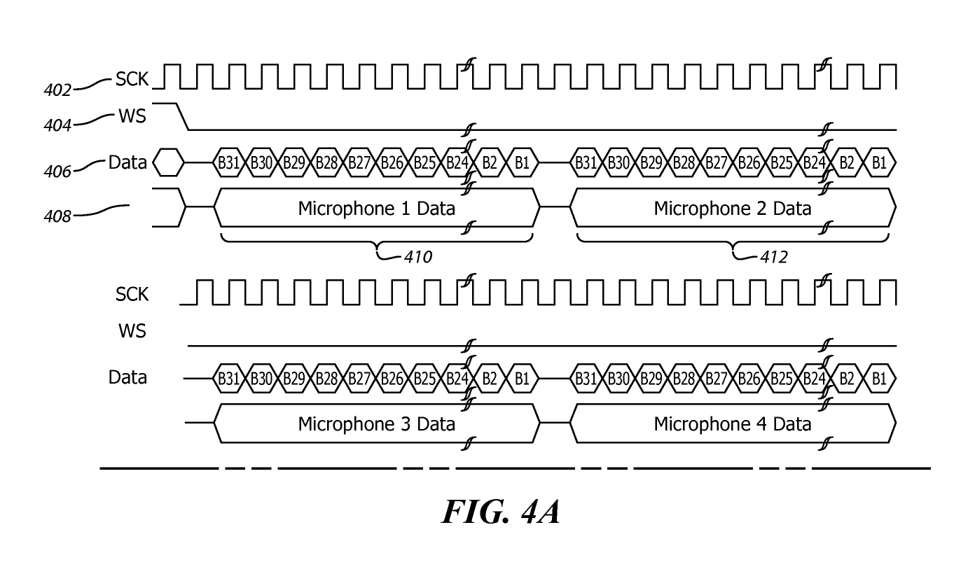

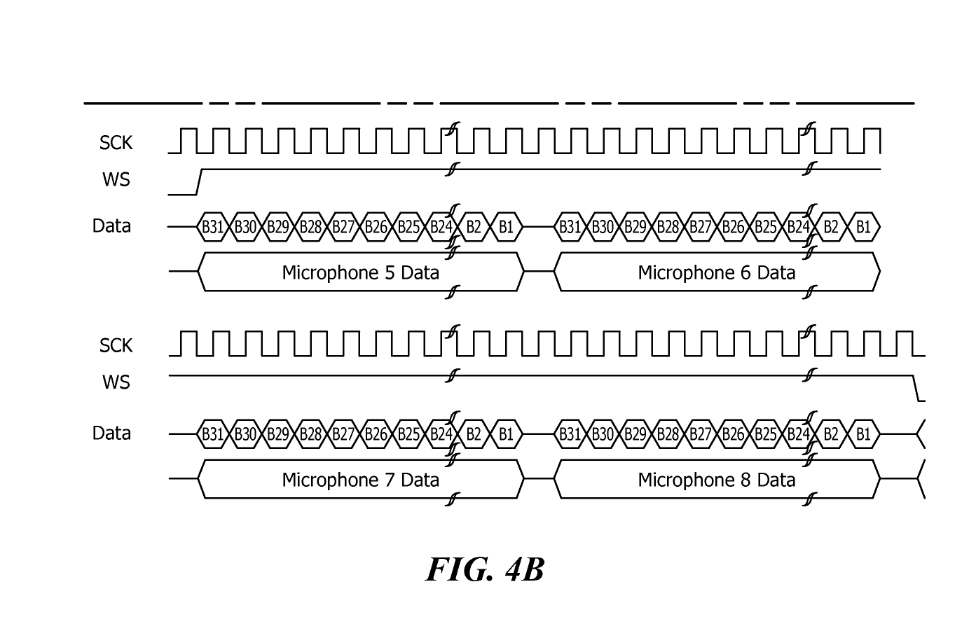

Referring now to FIG. 4, one example of a timing diagram illustrating system operation is described. The timing diagram of FIG. 4 is for an 8 microphone mode of operation. A clock 402, WS signal 404, Data line 406, and data from microphone 408 are shown. This timing diagram illustrates a sequence of operations when commands are not being issued to the microphone by the controller. Further, this sequence can be used to synchronize the microphones at power up. It can be seen that at a first time period 410, data from a first microphone is on the data bus. At a second time period 412, data from a second time period is on the data bus. The other subsequent periods correspond to transmission periods for the other microphones.

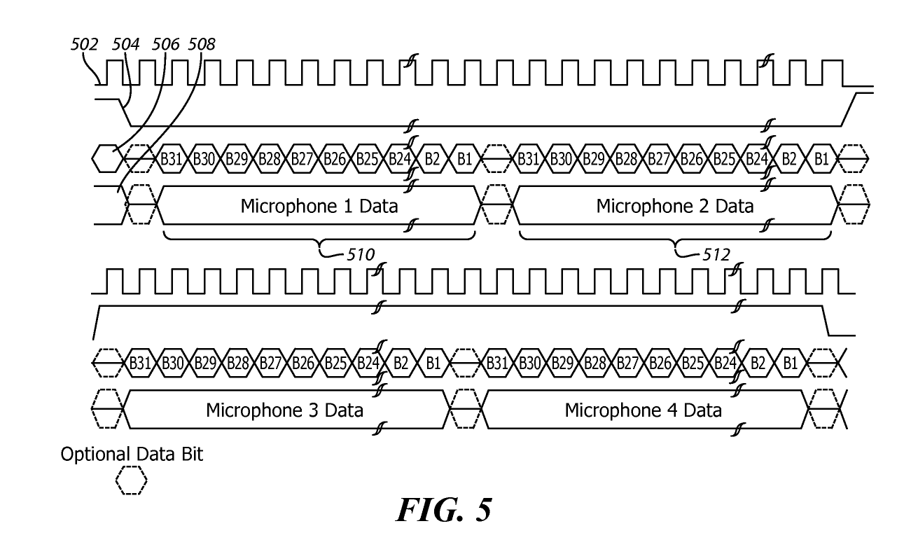

Referring now to FIG. 5, another example of a timing diagram illustrating system operation is described. The timing diagram of FIG. 5 is for a 4 microphone mode of operation. A clock 502, WS signal 504, Data line 506, and data from microphone 508 are shown. This timing diagram shows a sequence of operations that is used when commands are not being issued to the microphone. This sequence is also used to synchronize the microphones at power up.

It can be seen that at a first time period 510, data from a first microphone is on the data bus. At a second time period 512, data from a second time period is on the data bus. The other subsequent periods correspond to transmission periods for the other microphones.

As with the example of FIG. 4, this timing must be used to synchronize the bus at power up and used when commands are not being issued to the microphone. An optional data bit may also be used for transmissions.

Preferred embodiments of this invention are described herein, including the best mode known to the inventors for carrying out the invention. It should be understood that the illustrated embodiments are exemplary only, and should not be taken as limiting the scope of the invention.

What is claimed is:

1. A method, comprising:
coupling a plurality of sensors to a data transmission bus and a command line;
transmitting a marker across the command transmission line;
sensing the marker at each of the plurality of sensors;
at each of the plurality of sensors, transmitting data over the data bus at a predetermined time from the marker, such that each predetermined time for each of the plurality of sensors is different from the predetermined time at the other sensors, and such that data transmitted from each of the plurality of microphones does not interfere with data transmitted from others of the plurality of sensors.

2. The method of claim 1 wherein the plurality of sensors comprise a plurality of proximity sensors, a plurality of ambient light sensors, or a plurality of micro electro mechanical system (MEMS) microphones.

3. The method of claim 1, wherein the marker comprises a word strobe (WS) signal.

4. The method of claim 1, further comprising transmitting a clock signal to each of the plurality of sensors.

5. The method of claim 4, wherein a frequency of the clock signal is at least partially effective to configure each of the plurality of sensors.

6. The method of claim 4, wherein a frequency of the clock signal relates to a number of the sensors that are coupled to the data bus.

7. The method of claim 1, wherein the marker comprises a word strobe (WS), and the word strobe is removed and replaced by command and control signals.

8. The method of claim 1, wherein the data is audio data.

9. The method of claim 7, wherein the audio data is in a pulse code modulation (PCM) format.

10. A system, comprising:
a data bus;
a command line;
a plurality of sensors to the data transmission bus and the command line;
a controller coupled to the data transmission bus and the command line;
such that a marker is transmitted from the controller across the command transmission line and sensed at each of the plurality of sensors;
and such that at each of the plurality of sensors, data is transmitted over the data bus at a predetermined time from the marker, such that each predetermined time for each of the plurality of sensors is different from the predetermined time at the other sensors, and such that data transmitted from each of the plurality of sensors does not interfere with data transmitted from others of the plurality of sensors.

11. The system of claim 10 wherein the plurality of sensors comprise a plurality of proximity sensors, a plurality of ambient light sensors, or a plurality of micro electro mechanical system (MEMS) microphones.

12. The system of claim 10, wherein the marker comprises a word strobe (WS) signal.

13. The system of claim 10, further comprising a clock signal coupled from the controller to each of the plurality of sensors.

14. The system of claim 13, wherein a frequency of the clock signal is at least partially effective to configure each of the plurality of sensors.

15. The system of claim 13, wherein a frequency of the clock signal relates to a number of the sensors that are coupled to the data bus.

16. The system of claim 11, wherein the marker comprises a word strobe (WS), and the word strobe is removed and replaced by command and control signals.

17. The system of claim 11, wherein the data is audio data.

18. The system of claim 17, wherein the audio data is in a pulse code modulation (PCM) format.
